(19) United States
(12) Patent Application Publication
(10) Pub. No.: US 2025/0369693 A1
(43) Pub. Date: Dec. 4, 2025

(54) CONTAINERS, TRANSFER RECEPTACLES, SYSTEM THEREFROM AND METHOD FOR TRANSFERRING A SUBSTANCE BETWEEN BOTH

(71) Applicant: Kögel Filter GmbH Contecma-Filtration, Landau in der Pfalz (DE)

(72) Inventors: Jürgen KÖGEL, Burrweiler (DE); Tino FIEDLER, Landau (DE)

(73) Assignee: Kögel Filter GmbH Contecma-Filtration, Landau in der Pfalz (DE)

(21) Appl. No.: 19/218,767

(22) Filed: May 27, 2025

(30) Foreign Application Priority Data
May 29, 2024 (DE) 10 2024 115 096.3

(51) Int. Cl. F26B 25/06; A61J 1/20

(52) U.S. Cl. CPC F26B 25/063; A61J 1/2048

(57) ABSTRACT

For connecting a container for the production of freeze-dried, particularly pharmaceutical, products, containers are known that can be filled and emptied via an access opening. In order to enable easy transfer into a transfer receptacle, a container connection piece which can be sealingly connected to a receptacle connection piece of the transfer receptacle is provided. The system can be supplemented by a closure that can be opened in the connected state, allowing safe and contamination-free transfer from the container to the transfer receptacle.

### CROSS REFERENCE TO RELATED APPLICATIONS

Applicant claims priority under 35 U.S.C. § 119 of German Application No. 10 2024 115 096.3 filed May 29, 2024, the disclosure of which is incorporated by reference.

### BACKGROUND OF THE INVENTION

### 1. Field of the Invention

The present invention relates to a container, in particular a freeze-drying container, comprising a tub closed on all sides with an access opening in a tub lid, a transfer receptacle with a flexible outer shell which sealingly encloses a transfer volume, wherein a container connection piece is sealingly assigned to the flexible outer shell and can cooperate sealingly with a container connection piece of a container, in particular a freeze-drying container, a system comprising this and a method for transferring a substance from a container into a transfer receptacle.

### 2. Description of the Related Art

Such a method is already known from DE 10 2023 118 662 A1. Such a container is used for the production of freeze-dried products, especially pharmaceutical products. The container is specially designed to monitor the drying process. The said disclosure describes the attachment of a sensor sleeve which enables temperature monitoring in the product without interfering with the interior of the container.

In the field of freeze-drying containers, also known as lyophilization, it is common for them to be used for the storage and transport of substances, particularly in the pharmaceutical and chemical industries. Known systems typically include rigid or flexible containers equipped with various closure mechanisms to ensure safe storage and transport of the substances, as well as the possibility of freeze-drying.

Despite considerable progress in the field of such containers, challenges remain, particularly with regard to the tightness of the containers and the handling of the substances once they are to be removed from the containers. This is particularly critical in areas where high purity requirements exist, such as in pharmaceutical production or the food industry and especially in the handling of toxic substances.

### SUMMARY OF THE INVENTION

Against this background, the object of the present invention is to create a possibility to transfer substances from a container, in particular a freeze-drying container, to other locations without having to accept contamination and to protect the personnel from contact with the active ingredient or hazardous substance.

This object is achieved by a container as disclosed herein, as well as a transfer receptacle as disclosed herein. Furthermore, the problem is solved by a system comprising such a container and a transfer receptacle as disclosed herein and by a method for transferring a substance from a container into a transfer receptacle as disclosed herein. Practical embodiments of such container pumps are also disclosed.

This task is particularly addressed by a container designed as a freeze-drying container and comprising a fully enclosed tub equipped with an access opening in a tub lid. The access opening is sealed to the tub lid by a container connection piece, creating a passage which is in turn sealed with a container lid. The container lid is held in a clamp fit in the passage of the container connection piece. This arrangement can offer several advantages, including improved tightness and easier handling of the container.

The fully enclosed tub ensures that the contents of the container are protected from external influences, which is particularly important for the freeze-drying process, where the integrity of the contents is crucial. The container connection piece enables a secure and tight connection between the access opening and the tub lid, which can minimize the risk of leakage. The clamp fit of the container lid in the passage of the container connection piece can enable easy and quick opening and closing of the container without the need for additional tools. This can increase the efficiency of the work process and make operation easier. The specific arrangement and placement of the components are designed to optimize the container's tightness and handling, which can be particularly advantageous when freeze-drying sensitive, toxic substances. The technical design of the container can thus help to overcome the challenges of tightness and handling and enable more precise control over the freeze-drying process.

A fully enclosed tub with an access opening in a tub lid forms the basis of the container. This tub is designed to be completely enclosed to keep the contents safe and protected from external influences. The access opening in the tub lid allows access to the interior of the tub. The access opening can be incorporated into the lid either centrally or at the edge, either in the solid material of the lid or in a filter medium or filter membrane incorporated into the lid.

The access opening has a container connection piece that is sealingly connected to the tub lid. This prevents air or other substances from entering the container.

The container connection piece forms a passage. This passage serves as a channel through which access to the interior of the container is provided. The passage is an essential part of the connection piece and allows a substance contained in the container to be released to the outside.

The passage is sealed with a container lid. Its clamp fit ensures that the lid cannot be removed accidentally, thus ensuring the tightness and safety of the container. This makes it possible to operate, i.e. to remove, open or close, the container lid by hand as required through the flexible outer skin of a transfer receptacle that is to be connected to the container.

In particular, the container lid is equipped with means for gripping the container lid on an outer side facing away from the tub. These gripping means enable easier and safer handling of the container lid when opening and closing the access opening. The gripping means may, for example, be in the form of handles, tabs or similar devices that enable the user to remove or attach the container lid without great effort and without the need for additional tools. This is particularly advantageous in environments where fast and efficient handling is required, such as in laboratories or industrial applications where freeze-drying processes are carried out, and due to the fact that operation must be carried out through the material of the outer shell of the transfer receptacle.

According to a further embodiment, the container, in particular the freeze-drying container, comprises means for gripping the container lid, which comprise a handle. This specific embodiment significantly improves the handling and user-friendliness of the container. The handle attached to the container lid allows the user to grip and remove the lid more easily. The handle serves as an ergonomic solution that reduces the physical strain on the user and increases safety by providing a firm and secure grip. This is particularly important when the container lid is clamped into the passage of the container connection piece according to a preferred embodiment, since the clamp fit ensures a firm connection which could be difficult to release without suitable gripping means. Especially if the container is only equipped with a container lid, it must be possible to remove it without any additional tools, which is what the handle helps with. The handle can be made of different materials to meet the specific requirements of the application, such as stainless steel for high corrosion resistance or plastic for light weight and easy cleaning.

According to a further embodiment, the container comprises a sealingly closable filling nozzle which is associated with the container lid. The tightly sealable filling nozzle ensures that the contents of the container remain protected from external influences during the filling process and that no contamination occurs. This is particularly important for applications that have high purity requirements, when handling toxic substances such as in the pharmaceutical or food industries. The filling nozzle enables precise and controlled filling. In addition, the filling nozzle preferably has a handle. The handle allows the filling nozzle to be grasped to remove it from the container lid or allows the container lid to be grasped as a whole and pulled off.

According to a further embodiment, the container connection piece or the container lid has a first stop which prevents the container lid from being pushed into the tub. The container lid is held in a clamp fit, which means that it is securely fixed in the passage of the container connection piece by friction and mechanical tension. The new feature of the first stop, which is attached either to the container connection piece or to the container lid, acts as a mechanical barrier that prevents the container lid from being pushed too far into the tub. This ensures that the container lid remains in the optimal position for as long as necessary to ensure an effective seal, and in the event of an intervention, the container lid is prevented from falling into the tub and, due to its size, can only be retrieved by completely opening and thus contaminating the container. The first stop therefore makes handling and assembly of the container easier, as it provides a clear limit for inserting the container lid.

According to a further alternative embodiment, the container comprises means for gripping the container lid, said means comprising a first connecting element capable of being subjected to tensile loads. These specific mechanisms of communication between the components of the container and the container lid bring several advantages and innovations. Firstly, the first connecting element, which can withstand tensile loads, enables improved handling and securing of the container lid within the container connection piece. The tensile load ensures that the container lid can be firmly and securely connected to a receptacle lid of the transfer receptacle. This facilitates the transfer of force to the container lid even when direct access to the container lid is not possible due to the closure of the transfer receptacle.

In addition, the connecting element can be made of materials that are highly resistant to chemical and physical influences, which expands the possible uses of the container. The integration of this feature demonstrates a well thought out development of the container, which not only increases functionality and security, but also improves versatility and usability.

According to a further embodiment, the container comprises a first connecting element which is a screw thread, wherein this first connecting element can preferably be a blind bore with an internal thread. The screw thread as the first connecting element enables a precise and secure connection between the container lid and a receptacle lid of the transfer receptacle. The screw thread allows the container lid to be reliably connected to the receptacle lid and removed from the clamp fit with it, or pushed back into the clamping seat and thus closed again after materials have been removed from the container into the transfer receptacle. This type of connection is particularly advantageous as it allows for easy assembly and disassembly of the container lid.

A blind hole with an internal thread means that the thread ends in a hole that does not go completely through the material body, but stops at a certain point. This has the advantage of preventing foreign bodies or liquids from penetrating the interior of the container through the thread, which is particularly important when the container is used for sensitive applications, such as freeze-drying. After a separation between the container lid and the receptacle lid, the container lid remains tight and clean, and in particular, free of contamination. Other fasteners that engage by means of a rotating movement and are capable of withstanding tensile loads can also be used in an equivalent manner.

In particular, the container connection piece or the container lid also has a first stop, which in this case prevents the container lid from being pushed out of the tub. However, insertion should be expressly permitted for the reasons described below. This first stop ensures that the container lid, which is held in the clamp fit in the passage of the container connection piece, is not accidentally or due to external influences pushed out of its position and removed from the tub. The first stop acts as a physical barrier that blocks the container lid from sliding out, thus ensuring the tightness and integrity of the container. The first stop may be formed as a protruding edge or a ring attached either to the container connection piece or to the container lid. This design allows the container lid to be moved in only one direction, namely into the container connection piece, while movement in the opposite direction is prevented by the stop. By pushing in the container lid after connecting it to a container lid, the substance held in the container can be discharged into the transfer receptacle. The container lid is designed in such a way that when it is pressed in and protrudes into the container, i.e. in its open position, it allows the substance stored in the container to pass through.

In a further embodiment, the container is further improved in that a protective cover is detachably assigned to the container connection piece. The protective cover is used to protect the container connection piece from external influences, such as dust, dirt and mechanical damage, when the container is not in use or during storage and transport. This helps extend the service life of the container and ensures that the tightness and integrity of the container connection nozzle and the container lid are maintained. The protective cover can preferably be screwed on using an external thread assigned to the container connection piece. This screw connection allows for simple and secure fastening of the protective cover, which can be easily loosened if necessary. The external thread ensures a stable and secure connection that prevents the protective cover from accidentally coming loose. The use of a screw mechanism also creates an additional sealing layer that further minimizes the ingress of contaminants.

According to a further embodiment, the container connection piece is sealingly connected to the tub lid by stamping and/or welding. These specific mechanisms of connection between the container connection piece and the tub lid bring several advantages that significantly improve the functionality and reliability of the container. Stamping creates a mechanical connection that ensures high strength and tightness. This method is particularly advantageous because it enables a precise and repeatable connection that can be easily implemented in industrial production processes. Welding as an alternative or complementary method also offers significant advantages. Welding creates a fusion joint between the container connection piece and the tub lid, which ensures extremely high tightness and strength. This method is particularly suitable for applications where the highest demands are placed on tightness, such as freeze-drying containers operated under extreme temperature conditions. The choice between stamping and welding or a combination of both methods can be adapted according to the specific requirements and operating conditions of the container to ensure the best possible performance and reliability.

Furthermore, a transfer receptacle is described here which enables a secure and tight connection to a container, such as a freeze-drying container. The transfer receptacle is equipped with a flexible outer shell that tightly encloses a transfer volume. This flexible outer shell can adapt to different shapes and sizes, increasing the versatility and application possibilities of the container. A crucial component of the transfer receptacle is the receptacle connection nozzle, which can interact sealingly with a container connection nozzle of a container. This tight connection is essential to avoid contamination of the contents and to ensure the integrity of the transfer volume. The arrangement of the receptacle connection nozzle on the flexible outer shell enables a simple and secure connection that can be used in both sterile and non-sterile environments.

Technically, the container connection nozzle can be designed to allow quick and easy connection and disconnection, which can increase efficiency in processes, such as freeze-drying or aseptic processing. The flexible outer shell also allows the receptacle lid to be operated with the fingers through the outer shell without having to reach into the transfer volume.

According to one embodiment, the container connection piece is sealingly connected to the flexible outer shell by stamping and/or welding and/or clamping. These specific mechanisms of connection between the container connection piece and the flexible outer shell bring several technical advantages. Stamping enables a mechanical bond in which pressure and shaping create a tight connection that is both robust and durable. This method can be particularly advantageous when fast and cost-effective production is desired. Welding provides a thermal bond in which the materials form a homogeneous and tight connection through heating and subsequent fusion. This method ensures high strength and tightness, which is particularly important to reliably seal the transfer volume and thus prevent the penetration of contaminants. Clamping is a mechanical connection method in which a tight connection is achieved through the use of clamps or similar devices. This method can be applied flexibly and quickly and also allows for easy disassembly if maintenance or replacement is required. The combination of these connection methods achieves a high degree of flexibility in the production and application of the transfer receptacle, since the most suitable method or a combination of several methods can be selected depending on the specific requirements and operating conditions. The tight connection of the container connection piece with the flexible outer shell is crucial for the functionality of the transfer receptacle, as it ensures that the transfer volume is completely enclosed and protected from external influences. This is particularly relevant when the transfer receptacle is used in conjunction with a container, such as a freeze-drying container, as a high level of tightness is required in order not to interfere with the freeze-drying process.

Another advantageous feature is the assignment of a receptacle lid to the receptacle connection piece. The receptacle lid is used to close the receptacle connection piece when there is no connection to a container, thus protecting the transfer volume from contamination and unwanted leakage of substances. Another feature is the allocation of a second stop to the receptacle connection piece. This second stop plays a crucial role in limiting the movement of the receptacle lid between an open position and a closed position. The second stop ensures that the receptacle lid cannot be completely removed from the receptacle connection piece in the open position and closes securely and tightly in the closed position. This limitation of the movement of the receptacle lid by the second stop makes handling the transfer receptacle much easier, as the lid always remains in a defined position, thus preventing accidental loss or improper closing. In addition, this design contributes to safety and hygiene by minimizing the risk of contamination of the transfer volume.

In a specific embodiment, the transfer receptacle has a cylindrical receptacle lid. The cylinder jacket can be provided with a central constriction that enables a specific functionality. In this central constriction is the second stop, which serves as a mechanical stop or limit and thus controls the positioning and movement of the receptacle lid within the transfer receptacle. The inlet end face facing the transfer volume has at least one, preferably several, passage openings that allow the flow of material between the transfer volume and the central constriction. This allows for controlled and targeted material transfer, which is particularly advantageous for sensitive or valuable materials. The blocking end face, which faces away from the transfer volume, seals the receptacle connection piece in the closed position, ensuring a secure seal and preventing the ingress of contaminants or the leakage of contents. In the open position, the blocking end face is spaced from an outer edge of the receptacle connection piece, in particular offset into the connected container, which means that the receptacle connection piece is open in this position and material can be transferred through the passage opening into or out of the transfer volume.

In particular, the transfer receptacle is characterized in that a second connecting element is assigned to the end face facing away from the transfer volume. This second connecting element enables a connection to a first connecting element of a container lid of a container, so that the receptacle lid and the container lid can be moved together at the same time. This additional connection option allows for easier handling and assembly of the transfer receptacle.

According to a further embodiment, the transfer receptacle comprises a receptacle lid which is equipped with a handle on its side facing the transfer volume. The handle allows the user to grip the receptacle lid safely and comfortably even through the flexible outer shell of the transfer receptacle, which is particularly important when carrying out transfer processes.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings:

FIG. 1 shows an embodiment of a container and a transfer receptacle in a separated state, wherein the various components, such as the container connection piece, the container lid, the receptacle connection piece, the receptacle lid, and other elements are shown, in a schematic sectional view;

FIG. 2 shows the container and the transfer receptacle according to FIG. 1 in a connected state with closed lids;

FIG. 3 shows the container and the transfer receptacle according to FIG. 1 in a connected state with the lids open and in a discharge position with respect to the container;

FIG. 4 is a cross-sectional view through the inlet face of the container lid according to FIG. 1;

FIG. 5 shows the container and the transfer receptacle according to FIG. 1 in a connected state with the lids closed again;

FIG. 6 shows the container and the transfer receptacle according to FIG. 1 in a separated state with closed lids;

FIG. 7 shows a further embodiment of a container and a transfer receptacle with a flexible outer shell, in a separated state, wherein the container connection piece and the receptacle connection piece are shown, in a schematic sectional view;

FIG. 8 shows the container and the transfer receptacle according to FIG. 7 in a connected state with the container lid closed;

FIG. 9 shows the container and the transfer receptacle according to FIG. 7 in a connected state with the container lid open, as well as in a discharge position with respect to the container; and

FIG. 10 shows the container and the transfer receptacle according to FIG. 9 in a connected state with the container lid open, as well as in a discharge position with respect to the container, after separation of a portion of the transfer volume by a crimp connection.

### DETAILED DESCRIPTION OF PREFERRED EMBODIMENTS

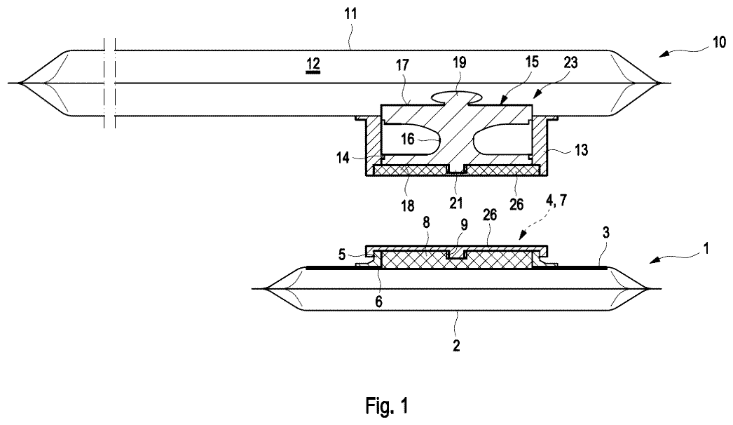

FIG. 1 shows a schematic representation of a system comprising a container 1 and a transfer receptacle 10, which is called LYOSAFE. The container 1 is designed in particular as a freeze-drying container and consists of a tub 2 closed on all sides with a tub lid 3. The tub lid 3 has an access opening 4 which is sealed by a container connection piece 5. The container connection piece 5 forms a passage 7 which is sealed with a container cover 8. The container lid 8 is held in the passage 7 of the container connection piece 5 in a clamp fit.

The container lid 8 is provided with gripping means, which in this case comprise a first connecting element 9 in the form of a blind bore with an internal thread. The container lid 8 is provided with a first stop 6 which prevents the container lid 8 from being pushed out of the tub 2.

The transfer receptacle 10 consists of a flexible outer shell 11 which tightly encloses a transfer volume 12. The transfer receptacle 10 is provided with a receptacle connection piece 13 which can cooperate sealingly with the container connection piece 5 of the container 1. The receptacle connection piece 13 is sealingly connected to the flexible outer shell 11 by stamping and/or welding and/or clamping.

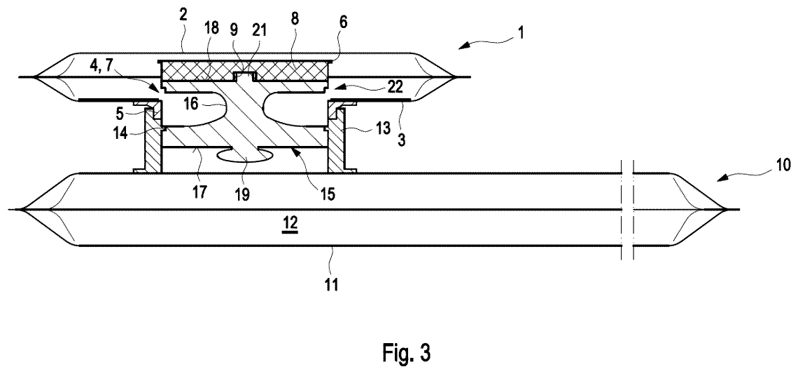

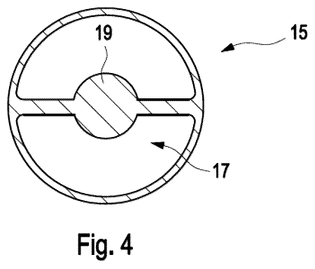

A receptacle lid 15 is associated with the receptacle connection piece 13 and has a second stop 14 which limits a movement of the receptacle lid 15 between an opening position 22 and a closing position 23. The receptacle lid 15 is cylindrical and has a central constriction in which the second stop 14 is located. An inlet end face 17 of the receptacle lid 15 facing the transfer volume 12 has, as shown in more detail in FIG. 4, at least one passage opening through which a substance received in the container 1 can pass between the transfer volume 12 and the central constriction 16. A blocking end face 18 facing away from the transfer volume 12 seals the receptacle connection piece 13 in the closed position 23 and is spaced from an outer edge of the receptacle connection piece 13 in the open position 22, as shown in FIG. 3.

On its side facing the transfer volume 12, the receptacle lid 15 is provided with a handle 19 which can be easily operated through the flexible outer shell. A protective cover 26 is initially detachably assigned to the container connection piece 5 and can preferably be screwed on using an external thread assigned to the container connection piece 5.

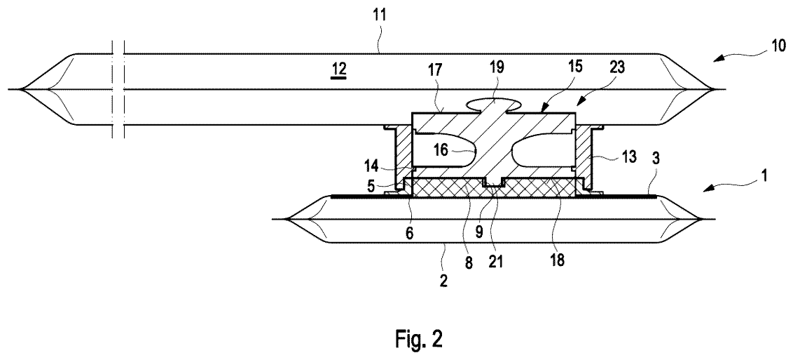

FIG. 2 shows a further view of the system, with the container lid 8 held in the passage 7 of the container connection piece 5. The container connection piece 13 of the transfer receptacle 10 can also be seen in this view, with the receptacle lid 15 shown in the closed position 23. The handle 19 of the receptacle lid 15 is also visible. In this position, the receptacle lid 15 with its second connecting element 21 is connected to the container lid 8 via its first connecting element 9 by a screw connection capable of withstanding tensile loads. Due to this connection, the container lid 8 can be operated together with the receptacle lid 15 via its handle 19, without the need for a separate handle on the container lid 8.

FIG. 3 shows the system according to FIG. 2, wherein with the aid of the handle 19 the receptacle lid 15 is now moved together with the container lid 8 towards the container 1 and protrudes into the container 1 with the container lid 8. The blocking end face 18 of the receptacle lid 15, which seals the receptacle in the closed position 23, is here in the open position 22 spaced from an outer edge of the receptacle connection piece 13 such that, in the shown overhead position, substance received in the container 1 can fall past the blocking end face 18 through the central constriction 16 and the inlet end face 17 into the transfer volume 12, as shown in FIG. 4.

FIG. 4 shows a plan view of the receptacle lid 15 in the plane of the inlet end face 17. The cylinder jacket of the receptacle lid 15 is provided with a central constriction 16, past which the substance can pass the cylindrical receptacle lid 15. The inlet end face 17 of the receptacle lid 15 has two kidney-shaped openings through which material can pass between the transfer volume 12 and the central constriction 16. The handle 19 is arranged centrally on the side of the container lid 15 facing the transfer volume 12.

The system enables the transfer of a substance from a container 1 accessible via a container connection piece 5 into a transfer receptacle 10 with a flexible outer shell 11 accessible via a receptacle connection piece 13. First, the container connection piece 5 is sealingly connected to the receptacle connection piece 13. Then the passage 7, which is sealed by a container lid 8, is opened. The substance held in the container 1 is transported by gravity through the passage 7 into the transfer receptacle 10 and enclosed there.

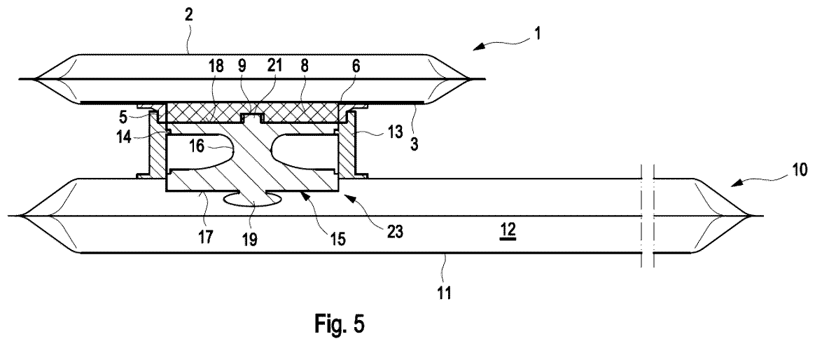

FIG. 5 shows a schematic representation of the system after closing the receptacle lid 15 connected to the container lid 8. The blocking end face 18 of the receptacle lid 15, which faces away from the transfer volume 12, now again seals the receptacle connection piece 13 in the closed position 23.

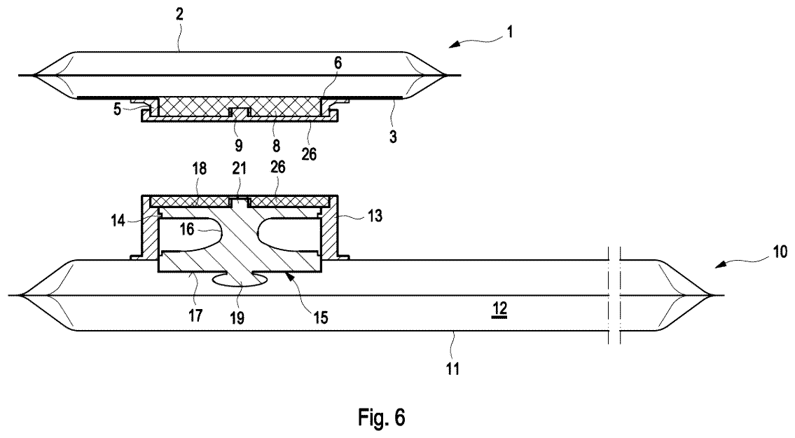

A second connecting element 21 is assigned to the end face of the receptacle lid 15 facing away from the transfer volume 12 and can interact with a first connecting element 9 of the container lid 8. In the present situation, this connection is now released in the transition to FIG. 6 by means of the handle 19 through the flexible outer shell 11 of the transfer receptacle 10.

FIG. 6 finally shows the container 1 and the transfer receptacle 10 in a separate position, wherein the container connection piece 5 of the container 1 and the container connection piece 13 of the transfer receptacle 10 are each provided with a protective cover 26 which is detachably screwed on.

The illustrated components and their arrangement enable a tight connection between the container 1 and the transfer receptacle 10, whereby a substance can be transferred from the container 1 into the transfer receptacle 10. The process comprises tightly connecting the container connection piece 5 to the receptacle connection piece 13, opening the passage 7 by removing the container lid 8 and conveying the substance through the passage 7 into the transfer receptacle 10. The substance is then enclosed in the transfer receptacle 10 by closing the passage 7 again. Due to the arrangement on top of each other, the contact surfaces between the lids cannot be contaminated with the product.

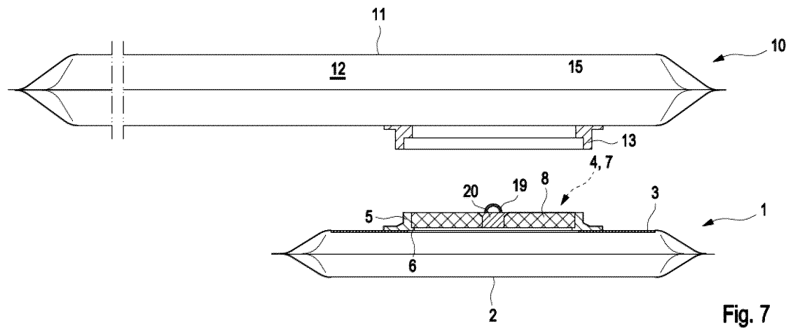

FIG. 7 shows a schematic representation of a container 1 and a transfer receptacle 10 in a non-connected state. The container 1 comprises a tub 2 closed on all sides with an access opening 4 in a tub lid 3. The access opening 4 is sealingly connected to a container connection piece 5, which forms a passage 7. The passage 7 is sealed with a container cover 8, which is held in a clamp fit. The container lid 8 has a handle on its outer side facing away from the tub 2, which serves as a means for gripping the container lid 8. In addition, a sealingly closable filling nozzle 20 is assigned to the container lid 8, wherein the handle in a specific embodiment is assigned to the filling nozzle 20 here.

The transfer receptacle 10 has a flexible outer shell 11 which tightly encloses a transfer volume 12. A receptacle connection piece 13 is sealingly connected to the flexible outer shell 11 and can cooperate sealingly with the container connection piece 5 of the container 1. In FIG. 7, the receptacle connection piece 13 of the transfer receptacle 10 is not yet connected to the container connection piece 5 of the container 1, which is shown by the dashed line.

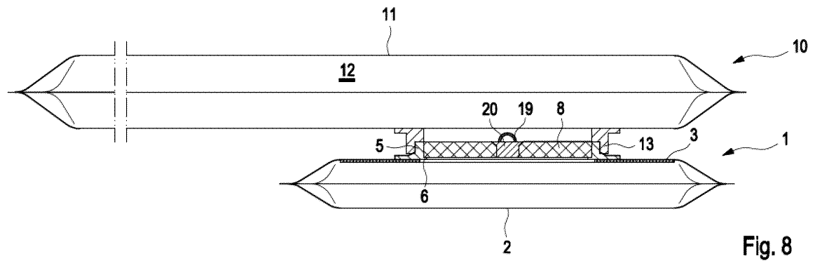

FIG. 8 shows the state in which the transfer receptacle 10 is connected to the container 1. The receptacle connection piece 13 of the transfer receptacle 10 is now sealingly connected to the container connection piece 5 of the container 1. The container lid 8 continues to be held in the passage 7 of the container connection piece 5 in a clamp fit. A first stop 6 is provided on the container connection piece 5, which prevents the container lid 8 from being pushed into the tub 2.

The flexible outer shell 11 of the transfer receptacle 10 allows adaptation to the volume of the material to be transferred. The receptacle connection piece 13 is sealingly connected to the flexible outer shell 11 by stamping and/or welding and/or clamping.

The transfer receptacle 10 and the container 1 form a system in which the container connection piece 5 and the receptacle connection piece 13 interact in a detachable but sealing manner to connect the container 1 to the transfer receptacle 10. This enables the safe transfer of material between the container 1 and the transfer receptacle 10.

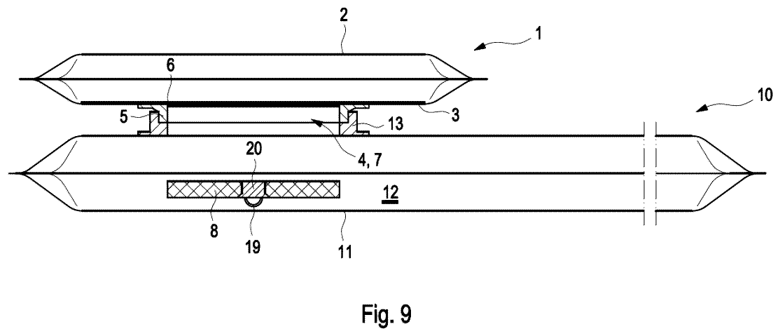

FIG. 9 shows the container 1 and the transfer receptacle 10 in a connected configuration. The container lid 8 is now pulled through the flexible outer shell 11 using the handle 19 on the filling nozzle 20 and is now in the transfer volume 12. The substance from container 1 can now pass unhindered into the transfer volume 12 with the help of gravity.

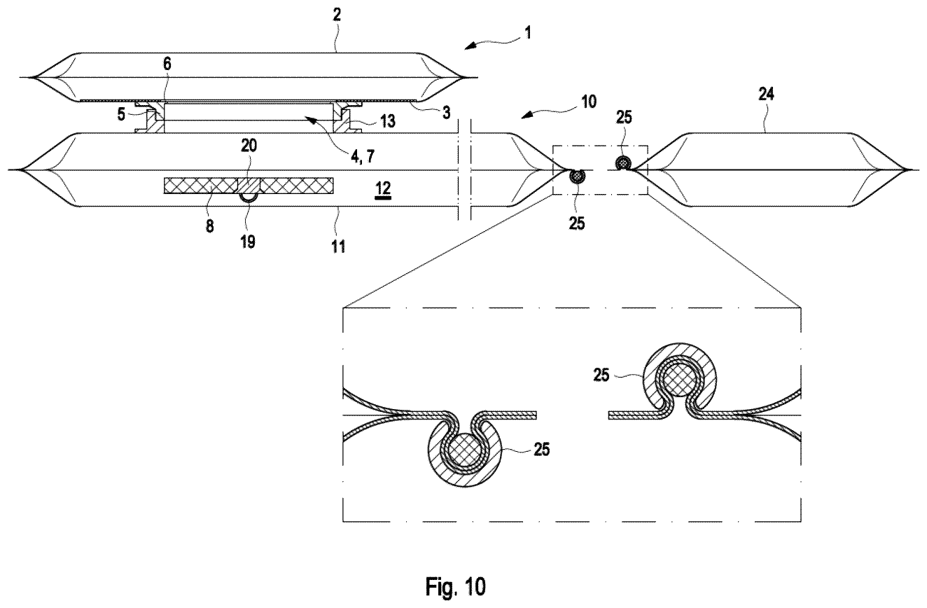

Finally, in FIG. 10, the substance has been introduced into a partial area 24 within the transfer volume 12 and this portion 24 has been closed off by means of crimp closures 25. Between the crimp closures 25, the portion 24 has been separated from the remaining transfer receptacle 10 and can now be handled separately.

The figures illustrate the process of transferring a substance from a container 1 to a transfer receptacle 10. First, the container connection piece 5 of the container 1 is sealingly connected to the transfer connection piece of the transfer receptacle 10. The container lid 8 is then removed, opening the passage and transporting the substance into the transfer receptacle 10 by gravity. Finally, the substance is enclosed in the transfer receptacle 10 by separating a portion 24 of the flexible outer shell 11 and sealing it tightly.

The above description therefore provides a possibility to transfer substances from a container, in particular a freeze-drying container, to other locations without having to accept contamination.

Although only a few embodiments of the present invention have been shown and described, it is to be understood that many changes and modifications may be made thereunto without departing from the spirit and scope of the invention.

### LIST OF REFERENCE SIGNS

1 Container
2 Tub
3 Tub lid
4 Access opening
5 Container connection piece
6 First stop
7 Passage
8 Container lid
9 First connecting element
10 Transfer receptacle
11 Flexible outer shell
12 Transfer volume
13 Receptacle connection piece
14 Second stop
15 Receptacle lid
16 Constriction
17 Inlet end face
18 Blocking end face
19 Handle
20 Filling nozzle
21 Second connecting element
22 Open position
23 Closed position
24 Portion
25 Crimp closure
26 Protective cover

What is claimed is:

1. A container (1), in particular freeze-drying container, comprising a tub (2) closed on all sides with an access opening (4) in a tub lid (3),
wherein the access opening (4) has a container connection piece (5) which is sealingly connected to the tub lid (3) and which forms a passage (7) which is sealingly closed by a container lid (8), the container lid (8) being held in the passage (7) of the container connection piece (5), preferably in a clamp fit.

2. The container (1) according to claim 1, wherein the container lid (8) has means for gripping the container lid (8) on an outer side facing away from the tub (2).

3. The container (1) according to claim 2, wherein the means for gripping the container lid (8) comprise a handle (19).

4. The container (1) according to claim 3, wherein a sealingly closable filling nozzle (20) is assigned to the container lid (8), wherein the filling nozzle (20) preferably has the handle (19).

5. The container (1) according to claim 3, wherein the container connection piece (5) or the container lid (8) has a first stop (6) which prevents the container lid (8) from being pushed into the tub (2).

6. The container (1) according to claim 2, wherein the means for gripping the container lid (8) comprise a first connecting element capable of being subjected to tensile stress.

7. The container (1) according to claim 6, wherein the first connecting element is a screw thread, preferably a blind bore with an internal thread.

8. The container (1) according to claim 6, wherein the container connection piece (5) or the container lid (8) has a first stop (6) which prevents the container lid (8) from being pushed out of the tub (2).

9. The container (1) according to claim 1, wherein a protective cover (26) is detachably associated with the container connection piece (5), which protective cover is preferably screwed on by means of an external thread associated with the container connection piece (5).

10. The container (1) according to claim 1, wherein the container connection piece (5) is sealingly connected to the tub lid (3) by stamping and/or welding.

11. A transfer receptacle (10) with a flexible outer shell which sealingly encloses a transfer volume (12), wherein a receptacle connection piece (13) is sealingly assigned to the flexible outer shell and can cooperate sealingly with a container connection piece (5) of a container (1), in particular a freeze-drying container.

12. The transfer receptacle (10) according to claim 11, wherein the receptacle connection piece (13) is sealingly connected to the flexible outer shell by stamping and/or welding and/or clamping.

13. The transfer receptacle (10) according to claim 11, wherein a receptacle lid (15) is assigned to the receptacle connection piece (13), wherein a second stop (14) is assigned to the receptacle connection piece (13), which stops a movement of the receptacle lid (15) between an open position (22) and a closed position (23).

14. The transfer receptacle (10) according to claim 13, wherein the receptacle lid (15) is cylindrical and has a cylinder jacket, which is assigned a central constriction in which the second stop (14) is located, wherein an inlet end face (17) facing the transfer volume (12) has at least one passage opening through which material can pass between the transfer volume (12) and the central constriction, wherein a blocking end face (18) facing away from the transfer volume (12) sealingly closes the receptacle connection piece (13) in the closed position (23) and is spaced from an outer edge of the receptacle connection piece (13) in the open position (22).

15. The transfer receptacle (10) according to claim 14, wherein the end face facing away from the transfer volume (12) is assigned a second connecting element which can interact with a first connecting element of a container lid (8) of a container (1).

16. The transfer receptacle (10) according to claim 13, wherein a handle (19) is assigned to the receptacle lid (15) on its side facing the transfer volume (12).

17. A system comprising a container (1) according to claim 1 and a transfer receptacle (10) with a flexible outer shell which sealingly encloses a transfer volume (12), wherein a receptacle connection piece (13) is sealingly assigned to the flexible outer shell and can cooperate sealingly with a container connection piece (5) of thee container (1), in particular a freeze-drying container and wherein the container connection piece (5) and the receptacle connection piece (13) interact detachably but sealingly to connect the container (1) to the transfer receptacle (10).

18. A system comprising a container (1) according to claim 6 and a transfer receptacle (10) with a flexible outer shell which sealingly encloses a transfer volume (12), wherein a receptacle connection piece (13) is sealingly assigned to the flexible outer shell and can cooperate sealingly with a container connection piece (5) of the container (1), in particular a freeze-drying container and wherein the container connection piece (5) and the receptacle connection piece (13) interact detachably but sealingly to connect the container (1) to the transfer receptacle (10).

19. A method for transferring a substance from a container (1) accessible via a container connection piece (5) into a transfer receptacle (10) having a flexible outer shell and accessible via a container connection piece (13), wherein firstly the container connection piece (5) is sealingly connected to the receptacle connection piece (13), and then a passage (7) formed by the container connection piece (5), which passage is sealingly closed by a container lid (8), is opened, and then the substance accommodated in the container (1) is conveyed through the passage (7) into the transfer receptacle (10) with the aid of gravity, and then the substance is enclosed in the transfer receptacle (10).

20. The method according to claim 19, wherein the container lid (8) is released via means connected to the container lid (8) for gripping the container lid (8), wherein the container lid (8) falls into the transfer receptacle (10) and remains there.

21. The method according to claim 20, wherein the substance in the transfer receptacle (10) is enclosed in a portion (24) of the transfer receptacle (10) by separating a region of the flexible outer shell, preferably by crimping, and this closed portion is separated.

22. The method according to claim 19, wherein the container lid (8) is connected via a first connecting element connected to the container lid (8) to a second connecting element which is arranged on a receptacle lid (15) closing the receptacle connection piece (13) and which can be subjected to tensile load, wherein the receptacle lid (15) with the container lid (8) is pressed into the container (1) and the passage (7) from the container (1) into the transfer receptacle (10) is thereby opened.

23. The method according to claim 22, wherein the substance is enclosed in the transfer receptacle (10) by closing the passage (7) from the container (1) into the transfer receptacle (10) by pulling on the second connecting element, which causes the container lid (8) to return to a sealing closure position in the passage (7) of the receptacle connection piece (5).

24. The method according to claim 23, wherein the container lid (8) is separated from the receptacle lid (15) by releasing the first connecting element from the second connecting element.
